(19) United States
(12) Patent Application Publication
(10) Pub. No.: US 2011/0314738 A1
(43) Pub. Date: Dec. 29, 2011

(54) STEEL SECURITY WINDOWS AND SLIDING DOORS

(76) Inventors: Terry Marcus Harriott, Kingston (JM); Jesse Harriott, Kingston (JM)

(21) Appl. No.: 12/823,120

(22) Filed: Jun. 24, 2010

(51) Int. Cl. E06B 9/01

(52) U.S. Cl. 49/50

(57) ABSTRACT

Steel frames attach to recesses in a wall opening frame. A steel band is spaced inwardly from each of two opposing sides of the steel frame. A series of interconnected vertical and horizontal steel grill members narrower in width than the steel bands extending between the steel bands and between the sides of the steel frame structure on the other two opposing sides to form a security grillwork. A glass rides on the steel bands and straddles the steel bands and the security grillwork to provide a glass wall inside the security grillwork and a glass wall outside the security grillwork. The glass frame slides on roller bearings in the steel frame. The security grillwork can slide with or separately from the glass frame if a lock is provided in the normally closed position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to relate generally to security window and security door systems, and in particular, in a first embodiment is a French design burglar-bar window including steel frames half the width of the window wherein the steel frames are fastened to the sides and the top and bottom of the wall, and a glass frame is provided on the inside and outside of the steel frame, which glass frames slides sideways on the steel frames for ventilation sliding on steel balls at the bottom. In a second embodiment, an emergency window having the same structure as the French window, except the steel frames are not fastened to the sides and the top and bottom of the walls. The frames can also slide from side to side when unlocked with a key. In a third embodiment, a French design burglar bar sliding door having the same structure as the emergency window, except it is a door instead of a window.

2. Description of Related Art Including Information Disclosed Under 37 CFR 1.97 and 1.98

All over the world residences and buildings have been burglarized by thieves gaining entrance through windows and children left unattended have fallen through upper-floor windows to their demise.

While security door and window systems have been the subjects of earlier patent documents, none provide the same flexibility of use in an unobtrusive desired style of window treatment and desired style of door treatment.

Prior art patents dealing with window and door security include the following: U.S. Pat. Nos. 5,862,645 issued to Lee, 5,575,321 issued to Currier, 6,813,861 issued to Petty, 4,226,049 issued to Maust, 4,822,084 issued to Fox, 4,841,673 issued to Tjomsland, 5,446,996 issued to Lamont, 5,575,321 issued to Currier, 5,787,642 issued to Coyle et al., 5,862,645 issued to Lee, 6,341,455 issued to Gunn, 6,813,861 issued to Petty, the following published US patent applications: 2006/0130404 by Lilly, 2007/0028536 by Pandorf, 2007/0033881 by Love, and Foreign patents: CA 2,104,429 (A1) in Canada, CN 1381666 (A) in China, CN 200978616 (Y) in China, CN 2911157 (Y) in China, WO 94/10416 (A1) in WIPO.

What is needed is a steel security grill structure which provides a desired appealing window treatment or door treatment sandwiched between the two sheets of glass in a two layer window frame in which the frame can slide relative to the grill structure.

### BRIEF SUMMARY OF THE INVENTION

An object of the present invention is to provide a steel security grill structure which provides a desired appealing window treatment or door treatment sandwiched between the two sheets of glass in a two layer window frame in which the frame can move relative to the grill structure, so that a French window treatment or French door treatment provides security windows and doors to prevent burglars from entering and prevent children from falling out.

In brief, the present invention comprises a French Design Burglar Bar™ window including steel frames half the width of the window. The steel frames are fastened to the sides and the top and bottom of the wall. A glass frame is provided on the inside and outside of the steel frame. The glass frames slides on a band of steel on each of two opposing sides of the steel frame spaced from the steel frame. The frames slide on roller bearings or steel balls at the bottom. In a second embodiment, an emergency window has the same structure as the French window, except the steel frames are not fastened to the sides and the top and bottom of the walls. The frames can also slide from side to side when unlocked with a key. In a third embodiment, a French design burglar bar sliding door having the same structure as the emergency window, except it is a door instead of a window.

With the introduction of the French Design Burglar-Bar Window™ of the present invention, parents will have no need to worry about their children falling through windows or homes being burglarized. At the same time the French Design Burglar-Bar Window™ would eliminate the unsightly independent grill and provide additional aesthetic to the homes/buildings.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a perspective view of the security window and security door steel grill of the present invention showing one side of the window supporting frame in an open position;

FIG. 2 is a cross-sectional view of the security window and security door steel grill of the present invention;

FIG. 3 is an elevational view of the security window and security door steel grill of the present invention with the window supporting frames in a closed position,

FIG. 4 is a perspective view of the steel grills of the security window and security door steel grill of the present invention.

### DETAILED DESCRIPTION OF THE INVENTION

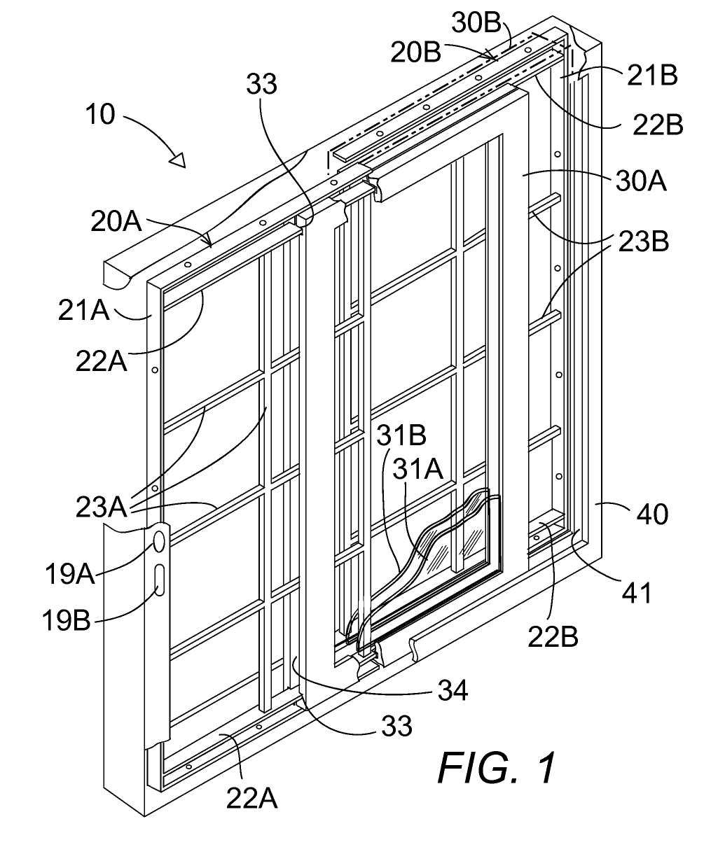

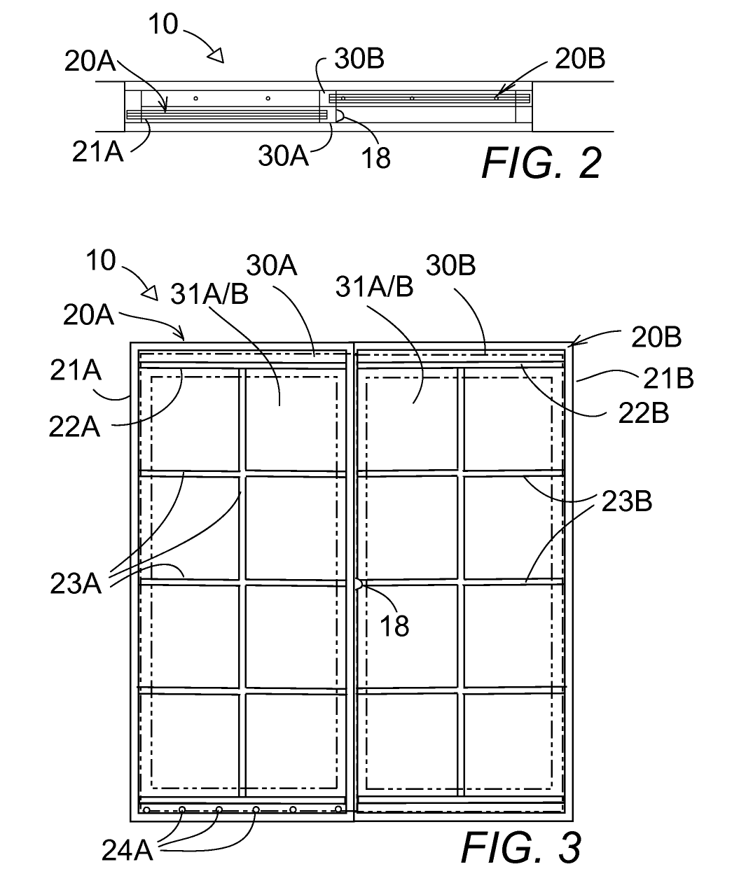

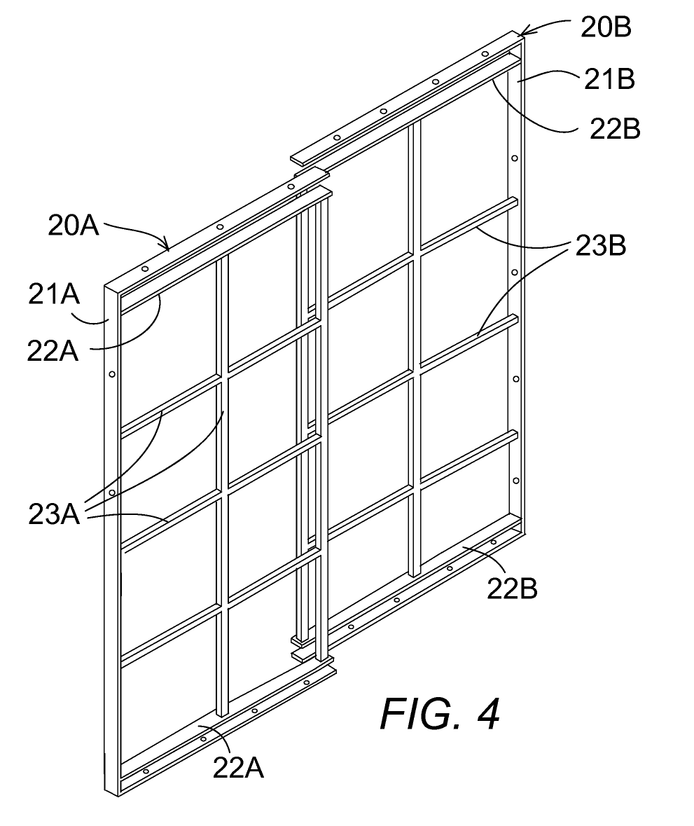

In FIGS. 1-4, a security window and door treatment apparatus 10 for windows and doorways comprises a security grillwork 20A and 20B for a wall opening comprising at least two rectangular steel frame structures 21A and 21B each secured on at least two sides to a perimeter of a wall opening frame 40 in recesses 41 around a perimeter of a rectangular wall opening in a wall of a structure. Each frame structure has an internal steel grill frames 23A and 23B securing a wall opening, and an overlapping pair of glass supporting frames 30A and 30B straddling each of the steel grid structures with a sheet of glass 31A and 31B on each side, the glass supporting frames 30A and 30B sliding on a band of steel 22A and 22B extending across each of two opposing sides of one of the steel grill frames 23A and 23B. A lock 18 locks the glass supporting frames closed, as shown in FIGS. 2 and 3.

An elongated rigid band of steel 22A and 22B spaced apart from the steel frame structure 21A and 21B on two opposing attached sides of each of the steel frame structures adjacent to but spaced apart from two opposing sides of the steel frame structure 21A and 21B recessing in the recesses 41 of the wall opening frame 40. The series of interconnected vertical and horizontal steel grill members 23A and 23B narrower in width than the steel bands 22A and 22B extend between the inner sides of the bands of steel 22A and 22B along the centerline of the steel bands on two opposing sides and extending between the sides of the steel frame structure 21A and 21B on the other two opposing sides. The interconnected steel grill members 23A and 23B forming a pattern of miniature rectangular security steel grill frames filling the rectangular wall opening. The steel grill frames are sufficiently small to prevent a human body from passing through any of the steel grill frames to prevent break ins and burglary and accidental falls through the wall opening.

The glass supporting frame 30A and 30B is supported by the bands of steel 22A and 22B on each of the steel frame structures 21A and 21B, the glass supporting frame 30A and 30B straddling the bands of steel 22A and 22B and straddling the steel grill frames 23A and 23B with each of the bands of steel fitting within a mating slot 33 and the steel grill frames in glass frame slot 34 inside of the glass supporting frame 30A and 30B so that the outer edges of the glass supporting frame contact the perimeter of the wall opening within the recesses 41 and contact the steel frame structures 21A and 21B with the sliding glass window frames riding on roller bearings 24A and 24B spaced along the inside faces of the steel frame structures 21A and 21B.

Each glass supporting frame 30 comprises a rectangular frame having an outer sheet of glass 31A permanently attached to the glass supporting frame outside of the steel grill frames 23A and 23B and an inner sheet of glass 31B permanently attached to the glass supporting frame inside the steel grill frames. At least one of the glass supporting frames is slidably attached to the steel band for alternate sliding to a closed position to enclose the wall opening with glass and alternately sliding open to admit air through a portion of the wall opening into the structure.

Each of the glass supporting frames 30A is parallel to and offset from an adjacent glass supporting frame 30B. The adjacent edges of the glass supporting frames contacting each other side by side so that the at least two glass supporting frames together contact the entire perimeter of the wall opening in the wall opening frame recess 41 to enclose the wall opening, thereby forming a security window and door treatment apparatus for windows and doorways.

The series of roller bearings 24A and 24B on an interior of the rectangular steel frame structure 21A and 21B are positioned along the length of the steel frame structure adjacent to and spaced apart from each of the bands of steel 22A and 22B so that the glass supporting frame 30A and 30B rolls on the roller bearings for ease of movement.

The bands of steel 22A and 22B may be oriented horizontally, as shown in FIGS. 1, 3, and 4, so that the at least one sliding glass supporting frame 30A slides horizontally. Alternately, the steel bands 22A and 22B may be oriented vertically so that the at least one sliding glass supporting frame 30A slides vertically.

At least one of the steel frames 20A and 20B may slide open to create an emergency escape opening and a lock provided, such as a key operated lock 19A or a combination lock 19B, to lock the at least one of the steel frames in a normally closed position to prevent passage through the wall opening.

At least one of the steel frames 20A or 20B may slide horizontally with at least one movable glass supporting frame 30A or 30B to form a sliding door to allow passage through the wall opening and a lock provided to lock the at least one movable glass supporting frame 30A or 30B and the steel frame 20A or 20B in a closed position.

Preferably, the pattern of miniature rectangular steel grill frames 23A and 23B is structured to create a desired type of window treatment, which may be a French window type of window treatment or the pattern of miniature rectangular steel grill frames 23A and 23B may be structured to create a desired type of door treatment such as a French door type of door treatment.

The security grillwork is preferably coated with a corrosion resistant and rust resistant coating such as a polymer or plastic coating.

In use, the invention in a first embodiment is preferably a French design burglar-bar window including steel frames each covering half the width of the window in a closed position, as in FIG. 3. The steel frames are preferably fastened to the sides and the top and bottom of the wall. A glass frame straddles the steel frame to provide a glass wall on both the inside and the outside of the steel frame. The glass frames slides open on the roller bearings on the steel frames for ventilation.

In a second embodiment, an emergency window has the same structure as the French window, except at least one of the steel frames is not fastened to the sides and the top and bottom of the walls. The unattached steel frames can slide from side to side when unlocked with a key.

In a third embodiment, a French design burglar prevention sliding door has the same structure as the emergency window, except it is a door instead of a window.

The French Design Burglar Bar™ of the present invention will preferably combine ½″ square steel for the steel security grill 23A and 23B and 2″ flat steel for the outer steel frame 21A and 21B and the bars of steel 22A and 22B in the production of the standard form of this product. For normal use, each window will incorporate two French grills that are placed on opposite sides of the window frame and are permanently fixed into the wall. Two (2) double-paned glass frames will then be able to slide over on both grills. Here, for further aesthetic value, the extreme top and bottom 2″flat steel of both grills will not be visible because they are recessed in the wall opening frame recesses 41 embedded into the window frame. This French Design Burglar-Bar™ Window will be able to accommodate the vertical and horizontal type depending on the choice of the purchaser. Windows and sliding doors will come equipped with bug screens. The product can be custom built to required specifications.

Along with The French Design Burglar Bar™ Window of the present invention, there is also The French Design Burglar Bar™ Emergency Window incorporated for emergency purposes. The grill in this Emergency Window will be a sliding grill which will not permanently fixed into the wall. It will be locked to the window frame and a key will be used to unlock the grill should an emergency arise.

Like the Emergency Window, The French Design Burglar Bar™ Sliding Door will provide security. It will have the capability to be used like a sliding patio/entrance door. However, the present invention will allow for the glass doors to slide open while the grill remains locked. A key will be used to open the grill as the owner desires.

It is understood that the preceding description is given merely by way of illustration and not in limitation of the invention and that various modifications may be made thereto without departing from the spirit of the invention as claimed.

What is claimed is:

1. Security window and door treatment apparatus for windows and doorways comprising:
a security grillwork for a wall opening comprising at least two rectangular steel frame structures each secured on at least two sides to a perimeter of a rectangular wall opening in a wall of a structure, an elongated rigid band of steel spaced apart from the steel frame structure on two opposing attached sides of each of the steel frame structures adjacent to but spaced apart from the edges of the wall opening, and a series of interconnected vertical and horizontal steel grill members narrower in width than the steel bands extending between the inner sides of the steel bands along the centerline of the steel bands on two opposing sides and extending between the sides of the steel frame structure on the other two opposing sides, the interconnected steel grill members forming a pattern of miniature rectangular steel grill frames filling the rectangular wall opening, the steel grill frames sufficiently small to prevent a human body from passing through any of the steel grill frames to prevent break ins and burglary and accidental falls through the wall opening;
at least one glass supporting frame supported by the steel bands on each of the steel frame structures, the glass supporting frame straddling the steel bands and steel grill frames with each of the steel bands fitting within a mating slot inside of the glass supporting frame so that the outer edges of the glass supporting frame contact the perimeter of the wall opening, the glass supporting frame comprising a rectangular frame having an outer sheet of glass permanently attached to the glass supporting frame outside of the steel grill frames and an inner sheet of glass permanently attached to the glass supporting frame inside the steel grill frames, at least one of the glass supporting frames being slidably attached to the steel band for alternate sliding closed to enclose the wall opening with glass and alternately sliding open to admit air through a portion of the wall opening into the structure, each of the glass supporting frames parallel to and offset from an adjacent glass supporting frame, the adjacent edges of the glass supporting frames contacting each other side by side so that the at least two glass supporting frames together contact the entire perimeter of the wall opening to enclose the wall opening, thereby forming a security window and door treatment apparatus for windows and doorways.

2. The apparatus of claim 1 further comprising a series of roller bearings on an interior of the rectangular steel frame structure positioned along the length of the steel frame structure adjacent to each of the bands of steel so that the glass supporting frame rolls on the roller bearings for ease of movement.

3. The apparatus of claim 1 wherein the steel bands are oriented horizontally and the at least one sliding glass supporting frame slides horizontally.

4. The apparatus of claim 1 wherein the steel bands are oriented vertically and the at least one sliding glass supporting frame slides vertically.

5. The apparatus of claim 1 wherein at least one of the steel frames slides open to create an emergency escape opening and further comprising a lock to lock the at least one of the steel frames in a closed position to prevent passage through the wall opening.

6. The apparatus of claim 1 wherein one of the steel frames slides with at least one movable glass supporting frame to form a sliding door to allow passage through the wall opening and further comprising a lock to lock the at least one movable glass supporting frame and the steel frame in a closed position.

7. The apparatus of claim 1 wherein the pattern of miniature rectangular steel grill frames is structured to create a desired type of window treatment.

8. The apparatus of claim 7 wherein the pattern of miniature rectangular steel grill frames is structured to create a French window type of window treatment.

9. The apparatus of claim 1 wherein the pattern of miniature rectangular steel grill frames is structured to create a desired type of door treatment.

10. The apparatus of claim 9 wherein the pattern of miniature rectangular steel grill frames is structured to create a French door type of door treatment.

11. The apparatus of claim 1 wherein the security grillwork is coated with a corrosion resistant and rust resistant coating.
